(19) United States
(12) Patent Application Publication
(10) Pub. No.: US 2015/0200995 A1
(43) Pub. Date: Jul. 16, 2015

(54) METHODS, SYSTEMS, AND MEDIA FOR PROVIDING AN ENTROPY SOURCE

(71) Applicant: Sonic IP, Inc., San Diego, CA (US)

(72) Inventor: Michael G. Kiefer, Lake Havasu City, AZ (US)

(21) Appl. No.: 14/134,076

(22) Filed: Dec. 19, 2013

Related U.S. Application Data
(63) Continuation of application No. 14/099,728, filed on Dec. 6, 2013.

(51) Int. Cl. H04L 29/08

(52) U.S. Cl. CPC H04L 67/02; H04L 67/32

(57) ABSTRACT

Methods, systems and media for providing generating random numbers are provided. In some embodiments, methods for generating random numbers are provided, the methods comprising: receiving a request message including a random sample value and a request for content; extracting the random sample value from the request message; adding the random sample value to an entropy pool; retrieving the content based on the request message; transmitting a response message including the content; and generating a random sample number based on the entropy pool.

### CROSS REFERENCE TO RELATED APPLICATIONS

This application claims the benefit of U.S. Provisional Patent Application No. 14/099,728, filed Dec. 6, 2013, and U.S. Provisional Patent Application No. 14/099,749, filed Dec. 6, 2013, each of which is hereby incorporated by reference herein in its entirety.

### TECHNICAL FIELDS

Methods, systems, and media for providing an entropy source are provided. More particularly, the disclosed subject matter relates to providing distributed entropy sources for random number generation.

### BACKGROUND OF THE INVENTION

Random number generators have been widely used in cryptographic applications. For example, conventional random number generators can generate random numbers that can be used as cryptographic keys based on user initiated events (e.g., keystrokes, mouse movements, etc.) and/or using hardware such as network interface cards, hardware security modules, etc. However, random numbers generated using these conventional approaches may not provide sufficient entropy for several reasons. For example, a conventional random number generator, such as a server including multiple virtual machines, may not have access to a sufficient amount of random data that can be used to generate random numbers due to a low level of or infrequent direct user interface interaction and reliance on the same hardware to obtain random data. As another example, an attacker may predict random numbers generated using these conventional approaches by spoofing user initiated events that serve as the basis of the random numbers. Therefore, new mechanisms for providing entropy sources for random number generation are desirable.

### SUMMARY OF THE INVENTION

In view of the foregoing, systems, methods, and media for providing an entropy source. In some embodiments, methods for providing an entropy source are provided, the methods comprising: receiving a user request for content; obtaining a random sample value in response to receiving the user request for content; generating, using a hardware processor, a request message including the random sample value based on the user request for content; transmitting the request message; receiving a response message corresponding to the request message; and rendering the content based on the response message.

In some embodiments, systems for providing an entropy source are provided, the systems comprising at least a hardware processor that is configured to: receive a user request for content; obtain a random sample value in response to receiving the user request for content; generate a request message including the random sample value based on the user request for content; transmit the request message; receive a response message corresponding to the request message; and render the content based on the response message.

In some embodiments, non-transitory computer-readable media containing computer-executable instructions that, when executed by a processing circuitry, cause the processing circuitry to perform a method for providing an entropy source are provided. In some embodiments, the method comprises: receiving a user request for content; obtaining a random sample value in response to receiving the user request for content; generating a request message including the random sample value based on the user request for content; transmitting the request message; receiving a response message corresponding to the request message; and rendering the content based on the response message.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 shows a generalized block diagram of an example of an architecture of hardware that can be used to generate random numbers in accordance with some embodiments of the disclosed subject matter;

FIG. 2 shows a flow chart of an example of a process for providing a distributed entropy source for random number generation in accordance with some embodiments of the disclosed subject matter;

FIG. 3 shows a flow chart of an example of a process for constructing an entropy pool using distributed entropy sources for random number generation in accordance with some embodiments of the disclosed subject matter;

FIG. 4 shows a flow chart of an example of a process for generating random numbers using an entropy pool in accordance with some embodiments of the disclosed subject matter; and

FIG. 5 shows an example of a request message including a random sample value in accordance with some embodiments of the disclosed subject matter.

### DETAILED DESCRIPTION

Mechanisms, which can be systems, methods, and media, for providing an entropy source are provided. In some embodiments, the mechanisms can provide distributed entropy sources for random number generation.

As referred to herein, the term “random number” can include any suitable length of bits, pseudorandom numbers, numbers, symbols, characters, and/or any other suitable values that can be regarded as being suitably random for an intended application.

In some embodiments, the mechanisms can construct an entropy pool based on random sample values provided by a set of entropy sources that are arranged in a distributed manner. For example, the mechanisms can receive random sample values from the set of entropy sources at random time instances and generate an entropy pool by combining the random sample values using a suitable hash function (e.g., the Secure Hash Algorithm (“SHA”)) and/or any other suitable algorithm that can combine multiple random sample values. In some embodiments, the mechanisms can receive and/or store a random sample value during each communication session between an entropy source and a server (e.g., a Hypertext Transfer Protocol (HTTP) session).

In some embodiments, the mechanisms can generate and/or transmit random sample values at random time instances to add entropy to the entropy pool and to improve the quality of the entropy pool. In some embodiments, generation and/or transmission of random sample values from one or more entropy sources can be triggered by any suitable event. For example, in response to receiving a user request for content (e.g., a Web page, a file, and/or any other suitable content) to be provided by a server, the mechanisms can obtain a random sample value and transmit the random sample value using a suitable communication protocol, such as HTTP. In a more particular example, upon a user typing a Uniform Resource Identifier (URI) associated with a Web page in a Web browser, the mechanisms can generate an HTTP request message including a request for the Web page and a random sample value (e.g., by incorporating the random sample value in a header of the HTTP request message) and transmit the request message over a suitable communication connection (e.g., a Transmission Control Protocol connection).

In some embodiments, upon receiving a request message including a random sample value, the mechanisms can extract the random sample value from the request message (e.g., by parsing the request message) and add the random sample value to the entropy pool. The mechanisms can then generate a response message containing the content requested by the request message (e.g., an HTTP response message including data that can be used to render a Web page requested by an HTTP request message).

In some embodiments, the mechanisms can reseed the entropy pool even when a given entropy source and/or a server becomes unavailable (e.g., when the entropy source and/or the server is compromised). For example, the mechanisms can reseed the entropy pool by receiving random sample values from one or more available entropy sources via new communication sessions (e.g., HTTP sessions) and adding the received random sample values to the entropy pool to produce an updated value of the entropy pool (e.g., by combining the received random sample values and a current value of the entropy pool).

In some embodiments, the mechanisms can generate one or more random numbers based on a value of the entropy pool (e.g., a current value of the entropy pool) using a suitable random number and/or pseudorandom number generating mechanism. Alternatively or additionally, the mechanisms can combine multiple random sample values into a combined value and generate one or more random numbers based on the combined value.

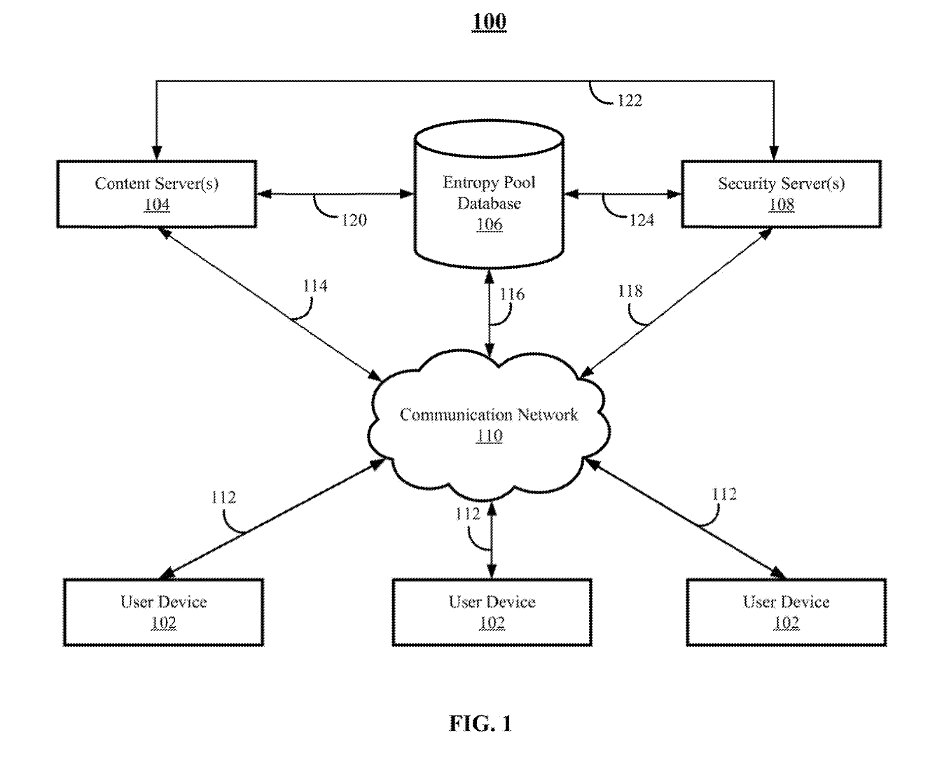

Turning to FIG. 1, a generalized block diagram of an example 100 of an architecture of hardware that can be used to generate random numbers is shown. As illustrated, architecture 100 can include one or more user devices 102, one or more content servers 104, an entropy pool database 106, one or more security servers 108, a communication network 110, communication paths 112, 114, 116, 118, 120, 122, and 124, and/or any other suitable components.

User device(s) 102 can be any suitable device that is capable of receiving user input, obtaining random sample values, generating and/or transmitting request messages including random sample values, and/or performing any other suitable functions.

Content server(s) 104 can be any device that is capable of receiving and processing a request message, extracting a random sample value from a request message, sending a response message, and/or performing any other suitable functions.

In some embodiments, multiple user devices 102 can generate and/or transmit random sample values at random time instances to add entropy to architecture 100. For example, in response to receiving a user request for content (e.g., a user entering a Universal Resource Identifier (URI) associated with the content in a Web browser), a user device 102 can obtain a random sample value and transmit the random sample value to the content server using a suitable communication protocol, such as the Hypertext Transfer Protocol (HTTP), the Hypertext Transfer Protocol Secure (HTTPS), the File Transfer Protocol (FTP), and/or any other suitable communication protocol. For example, user device 102 can generate an HTTP request message including the random sample value (e.g., by inserting the random sample value into a header of the HTTP request message). User device 102 can then transmit the request message over a suitable communication connection, such as a Transmission Control Protocol (TCP) connection.

In some embodiments, content server(s) 104 can receive multiple random sample values from a set of user devices 102 and generate an entropy pool by combining the random sample values (e.g., using a suitable hash function and/or any other suitable algorithm that can combine multiple random sample values).

In some embodiments, the set of user devices 102 can be arranged in a distributed manner and can provide distributed entropy sources. In some embodiments, the set of user devices 102 can have various hardware configurations (e.g., memory, hardware processors, form factors, and/or any other suitable hardware configurations) and can operate in various states (e.g., temperatures, languages, locations, and/or any other suitable states) to add entropy to architecture 100.

In some embodiments, content server(s) 104 can wait for a request message when performing other suitable functions, such as processing request messages, generating and/or transmitting response messages.

In some embodiments, upon receiving a request message including a random sample value, content server(s) 102 can extract the random sample value from the request message and add the random sample value to the entropy pool (e.g., by combining the random sample value and a current value of the entropy pool to generate an updated value of the entropy pool).

Entropy pool database 106 can include any device that is capable of storing random sample values, entropy pools, and/or any other suitable data, such as memory, a disk drive, a network drive, a database, a server, and/or any other suitable storage device.

Security server(s) 108 can include any suitable device that is capable of receiving random sample values, receiving and/or generating entropy pools, generating and/or transmitting random numbers, and/or performing any other suitable functions.

In some embodiments, security server(s) 108 can receive a value of an entropy pool from entropy pool database 106 and generate one or more random numbers based on the value of the entropy pool. In some embodiments, security server(s) 108 can receive random sample values from entropy pool database 106 and generate one or more random numbers based on the random sample values (e.g., by combining the random sample values into a combined value and use the combined value as a random seed).

In some embodiments, security server(s) 108 can store the random numbers in a suitable storage device, such as entropy pool database 106 and/or any other suitable storage device that is capable of storing random numbers.

Additionally or alternatively, security server(s) 108 can transmit the random numbers to content server(s) 104 and/or any other suitable server to implement an encrypted communication protocol, such as an Hypertext Transport Protocol Secure (HTTPS) and/or any other suitable communication protocol that utilizes a cryptographic protocol, such as Security Sockets Layer (SSL), Transport Layer Security (TLS), and/or any other suitable cryptographic protocol.

In some embodiments, each of user device(s) 102, content server(s) 104, entropy pool database 106, and security server(s) 108 can include and/or be any of a general purpose device such as a computer or a special purpose device such as a client, a server, and/or any other suitable device. Any of these general or special purpose devices can include any suitable components such as a hardware processor (which can be a microprocessor, digital signal processor, a controller, and/or any other suitable hardware processor.), memory, communication interfaces, display controllers, input devices, and/or any other suitable components. For example, each of user device(s) 102, content server(s) 104, entropy pool database 106, and security server(s) 108 can be implemented as or include a personal computer, a tablet computer, a wearable computer, a multimedia terminal, a mobile telephone, a gaming device, a set-top box, a television, and/or any other suitable device. Moreover, each of user device(s) 102, content server(s) 104, entropy pool database 106, and security server(s) 108 can comprise a storage device, which can include a hard drive, a solid state storage device, a removable storage device, and/or any other suitable storage device. Each of user device(s) 102, content server(s) 104, entropy pool database 106, and security server(s) 108 can be located at any suitable location.

In some embodiments, each of user device(s) 102, content server(s) 104, entropy pool database 106, and security server(s) 108 can be implemented as a stand-alone device or integrated with other components of system 100. For example, content server(s) 104, entropy pool database 106, and security serer(s) 108 can be implemented as one system in some embodiments.

Communication network 110 can be any suitable computer network such as the Internet, an intranet, a wide-area network (“WAN”), a local-area network (“LAN”), a wireless network, a digital subscriber line (“DSL”) network, a frame relay network, an asynchronous transfer mode (“ATM”) network, a virtual private network (“VPN”), a satellite network, a mobile phone network, a mobile data network, a cable network, a telephone network, a fiber optic network, and/or any other suitable communication network, or any combination of any of such networks.

In some embodiments, communication network 110 can be connected to user device(s) 102, content server(s) 104, entropy pool database 106, and security server(s) 108 through communication paths 112, 114, 116, and 118, respectively. In some embodiments, content server(s) 104 can be connected to entropy pool database 106 and security server(s) 108 through communication paths 120 and 122, respectively. In some embodiments, entropy pool database 106 can be connected to security server(s) 108 through communication path 124.

Communication paths 112, 114, 116, 118, 120, 122, and 124 may separately or together include one or more communication paths, and can be any suitable communication links, such as network links, dial-up links, wireless links, hard-wired links, any other suitable communication links, or a combination of such links.

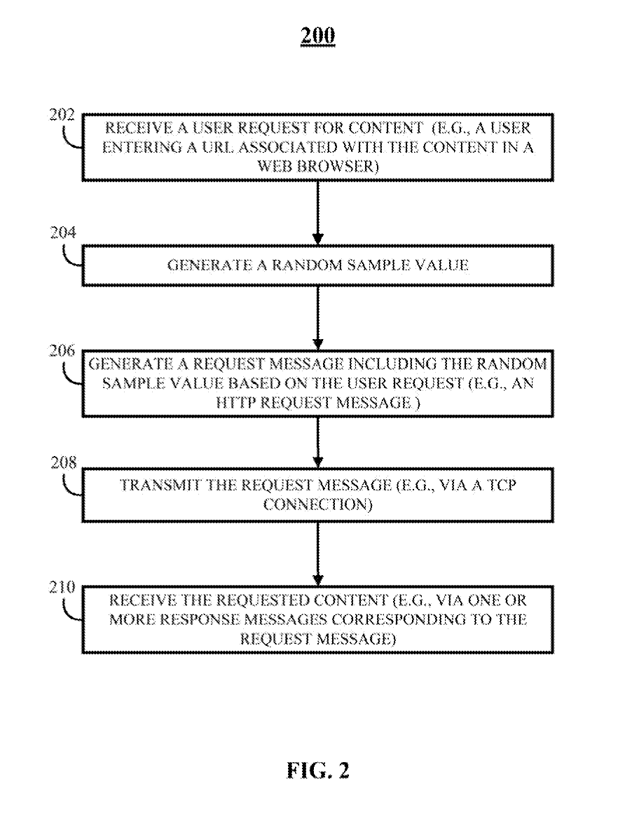

Turning to FIG. 2, an example 200 of a process for providing a distributed entropy source for random number generation in accordance with some embodiments of the disclosed subject matter is shown. In some embodiments, process 200 can be implemented by one or more components of architecture 100 of FIG. 1, such as one or more user devices 102.

As illustrated, process 200 can begin by receiving a user request for content at 202. Examples of content can include a Web page, an image, a video, a file, and/or any other suitable content.

The user request can be received in any suitable manner. For example, the user request can be received as a user entering a Uniform Resource Identifier (URI) associated with the content in a suitable Web browser. As another example, the user request can be received as a user searching for the content using a suitable search mechanism. As yet another example, the user request can be received as a user selection of a hyperlink associated with the content.

At 204, process 200 can generate a random sample value. The random sample value can include one or more suitable random numbers, pseudorandom numbers, and/or any other suitable values that can be regarded as being suitably random, and can comprise any suitable length of bits, numbers, symbols, characters, and/or any other suitable components.

The random sample value can be generated in any suitable manner. For example, the random sample value can be generated based on one or more random events. In a more particular example, process 200 can measure a set of random events, such as user keystrokes, mouse movements, network hits, disk-head seek times, and/or any other suitable random events. Process 200 can then convert the measured random events (e.g., the timing of a set of user keystrokes) into one or more random bits.

In another more particular example, process 200 can receive a random signal, such as a thermal noise signal, a radio noise signal, a signal representing clock drift in multiple clocks, and/or any other suitable signal representing any suitable random physical phenomenon. Process 200 can then convert the random signal into a random bit sequence (e.g., by amplifying, filtering, sampling, digitizing, and/or processing the random signal in any other suitable manner).

As another example, the random sample value can be generated using a mechanism that can produce random numbers based on a random seed, such as a linear congruential generator, a linear feedback shift register, a probability density function, “dev/random” implemented in LINUX, and/or any other suitable mechanism that can produce random numbers. In some embodiments, a random seed can include any suitable value and can be generated in any suitable manner. For example, a random seed can include one or more random bits generated based on one or more random events as described above.

At 206, process 200 can generate a request message including the random sample value based on the user request. The request message can include any suitable information about the random sample value, the requested content, and/or any other suitable information. For example, the request message can include a header containing the random sample value.

As another example, the request message can include one or more identifiers that can identify the name of the requested content, the location of the requested content, a server that can provide the requested content, and/or any other suitable information that can be used to identify and/or retrieving the requested content.

As another example, the request message can include information about a communication protocol via which the content can be requested and/or received, such as the HTTP, the HTTPS, the FTP, and/or any other suitable communication protocol.

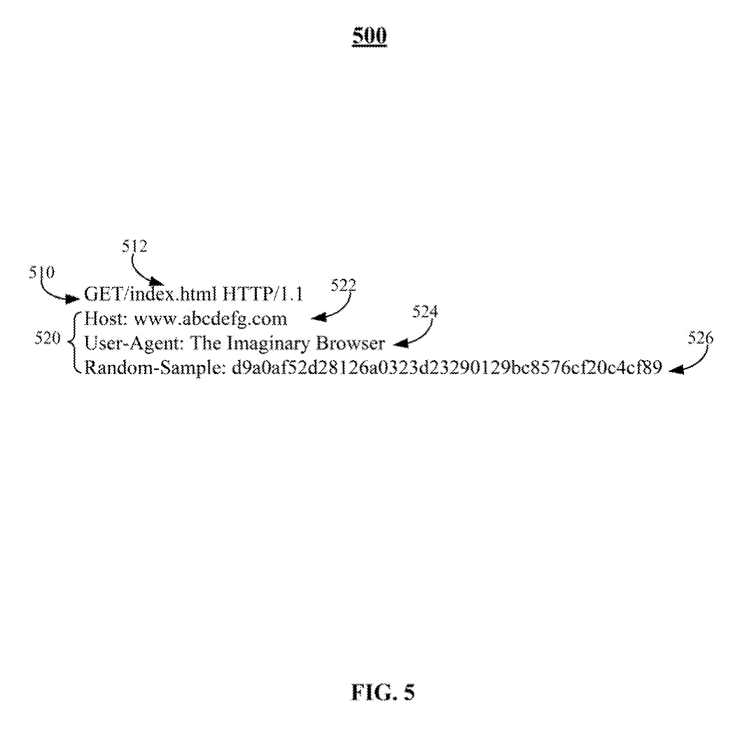

In a more particular example, as shown in FIG. 5, a request message 500 can be used to request content from a server in some embodiments. As illustrated, request message 500 can include a request component 510, a header 520, and/or any other suitable components.

In some embodiments, request component 510 can include a request for content and can identify the name and/or the location of the requested content using one or more suitable identifiers, such as an identifier 512 including a path associated with the requested content.

In some embodiments, header 520 can include a host component 522, a user agent component 524, a random sample component 526, and/or any other suitable component. Host component 522 can identify a server that can provide the requested content by a domain name, an Internet Protocol (IP) address, and/or any other suitable identifier associated with the server. User agent component 524 can identify a user agent that initiated the request message, such as a Web browser. Random-sample component 526 can include the random sample value generated at 204.

Referring back to FIG. 2, the request message can be generated in any suitable manner in some embodiments. For example, the request message can be generated by invoking a function in a client library that is capable of obtaining a random sample value and incorporating the random sample value into a request message. In a more particular example, an HTTP request message can be generated using an HTTP client library, such as CURL, LIBCURL, and/or any other suitable HTTP client library.

At 208, process 200 can transmit the request message to the server. The request message can be transmitted in any suitable manner. For example, the request message can be transmitted over a Transmission Control Protocol (TCP) connection and/or any other suitable communication connection.

At 210, process 200 can receive the requested content. The requested content can be received in any suitable manner. For example, the requested content can be received via one or more response messages corresponding to the request message. In a more particular example, the response message(s) can include the requested content (e.g., a requested file), data that can be used to render the requested content (e.g., one or more HyperText Markup Language (HTML) files, images, scripts, style sheets, audio files, and/or any other suitable data that can be used to render a Web page), and/or any other suitable data.

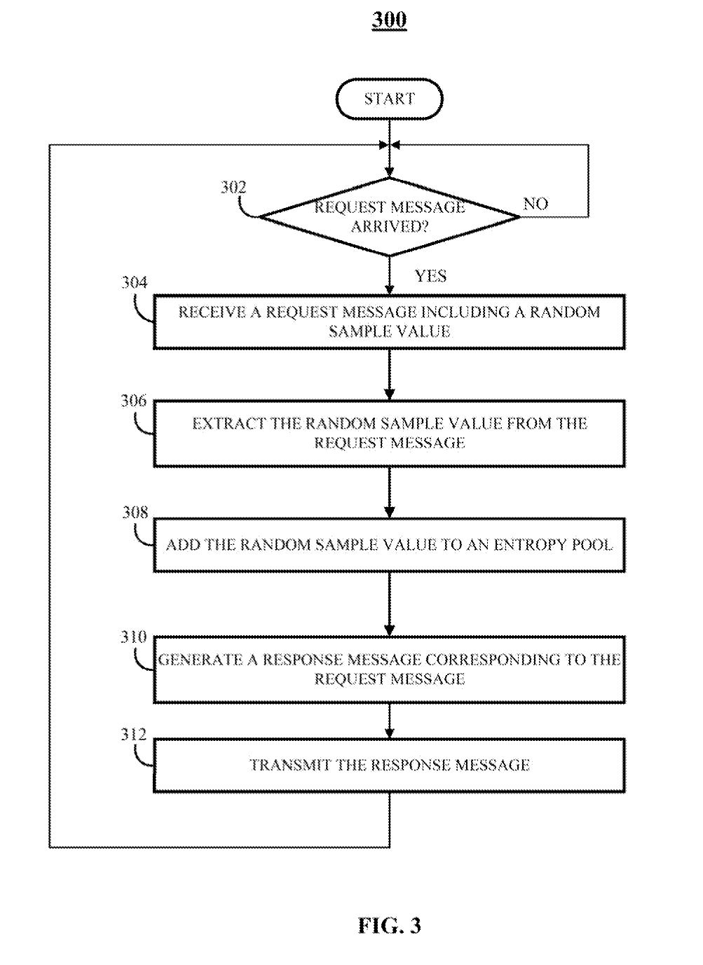

Turning to FIG. 3, an example 300 of a process for constructing an entropy pool using distributed entropy sources for random number generation in accordance with some embodiments of the disclosed subject matter is shown. In some embodiments, process 300 can be implemented by one or more components of architecture 100 of FIG. 1, such as one or more content servers 104.

As illustrated, process 300 can begin by waiting for a request message to arrive at 302. For example, process 300 can listen on a particular port on a server and determine whether a request message has arrived at the port. In some embodiments, while waiting, process 300 can process request messages, generate and/or transmit response messages, and/or perform any other suitable function.

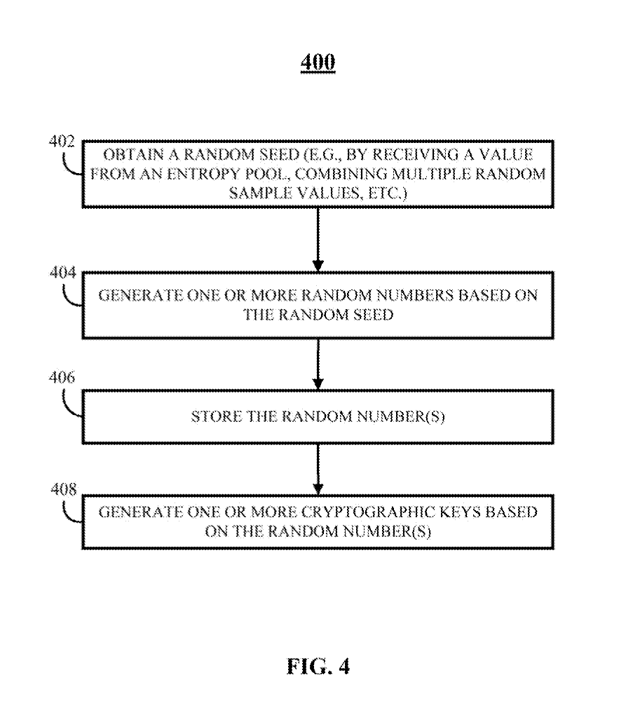

At 304, process 300 can receive a request message including a random sample value. Any suitable request message can be received in any suitable manner. For example, a request message described in connection with FIG. 2 can be received in some embodiments. In a more particular example, as described in connection with FIG. 4, the request message can include a header containing a random sample value, a request for content, and/or any other suitable component.

Next, at 306, process 300 can extract the random sample value from the request message. The random sample value can be extracted in any suitable manner. For example, the random sample value can be extracted by parsing the request message to obtain a portion of the request message that contains the random sample value. In a more particular example, in some embodiments in which a request message 500 of FIG. 5 is received at 304, process 300 can parse header 510 to extract the random sample value contained in random sample component 526.

Referring back to FIG. 3, at 308, process 300 can add the random sample value to an entropy pool. The random sample value can be added to an entropy pool in any suitable manner. For example, the random sample value can be added to an entropy pool by combing the random sample value and a current value of the entropy pool to generate an updated value of the entropy pool. In a more particular example, process 300 can combine the random sample value and the current value of the entropy pool using a suitable hash function (e.g., the SHA) and/or any other suitable algorithm that can combine a random sample value and a value of an entropy pool.

In some embodiments, the updated value of the entropy pool and/or the random sample value can be stored in a suitable storage device that is capable of storing and/or managing a set of random sample values and/or an entropy pool, such as an entropy pool database 106 of FIG. 1.

At 310, process 300 can generate a response message corresponding to the request message. The response message can include any suitable information and can be generated in any suitable manner. For example, the response message can be generated by identifying and retrieving the content requested by the request message. In a more particular example, the content can be identified and/or retrieved based on one or more identifiers in the request message that can identify the name and/or the location of the requested content, such as an identifier including a path associated with the requested content.

At 312, process 300 can transmit the response message. The response message can be transmitted in any suitable manner. For example, the response message can be transmitted over a suitable communication connection, such as a TCP connection.

In some embodiments, process 300 can loop back to 302 after performing 312.

Turning to FIG. 4, an example 400 of a process for generating random numbers using an entropy pool in accordance with some embodiments of the disclosed subject matter is shown. In some embodiments, process 400 can be implemented by one or more components of architecture 100 of FIG. 1, such as one or more security servers 108 and/or content servers 104.

As illustrated, process 400 can begin by obtaining a random seed at 402. The random seed can be obtained in any suitable manner. For example, a random seed can be obtained by receiving a value from an entropy pool (e.g., a current value of the entropy pool). In some embodiments, the entropy pool can be constructed using distributed entropy sources (e.g., by implementing process 200 of FIG. 2 and/or process 300 of FIG. 3 as described above).

As another example, a random seed can be obtained by combining multiple random sample values using a suitable hash function (e.g., the SHA) and/or any other suitable algorithm that can combine multiple random sample values. In some embodiments, the random sample values can be obtained based on a set of request messages and response messages as described above in connection with FIGS. 2 and 3.

Next, at 404, process 400 can generate one or more random numbers based on the random seed. The random number(s) can be generated in any suitable manner. For example, a random number can be generated based on the random seed using any suitable mechanism, such as a linear congruential generator, a linear feedback shift register, a probability density function, “/dev/random” implemented in LINUX, a hash function, a cipher function, and/or any other suitable random number and/or pseudorandom number generating mechanism.

In some embodiments, at 406, process 400 can store the random number(s). The random number(s) can be stored in any suitable storage device, such as an entropy pool database 106 of FIG. 1 and/or any other suitable storage device that is capable of storing random numbers.

In some embodiments, at 408, process 400 can generate one or more cryptographic keys based on the random number(s). Examples of cryptographic keys can include an encryption key, a decryption key, and/or any other suitable cryptographic key that can be used to implement a cryptographic protocol, such as Security Sockets Layer (SSL), Transport Layer Security (TLS), and/or any other suitable cryptographic protocol.

The cryptographic keys can be generated in any suitable manner. For example, a random number generated at 404 can be used as a cryptographic key in some embodiments. As another example, a cryptographic key can be generated based on the random number(s) using a hash function, such as a cipher function, and/or any other suitable function that can produce a cryptographic key using one or more random numbers.

It should be noted that processes 200, 300, and 400 of FIGS. 2, 3, and 4 can be performed concurrently in some embodiments. It should also be noted that the above steps of the flow diagrams of FIGS. 2-4 may be executed or performed in any order or sequence not limited to the order and sequence shown and described in the figures. Furthermore, it should be noted, some of the above steps of the flow diagrams of FIGS. 2-4 may be executed or performed substantially simultaneously where appropriate or in parallel to reduce latency and processing times. And still furthermore, it should be noted, some of the above steps of the flow diagrams of FIGS. 2-4 may be omitted.

In some embodiments, any suitable computer readable media can be used for storing instructions for performing the processes described herein. For example, in some embodiments, computer readable media can be transitory or non-transitory. For example, non-transitory computer readable media can include media such as magnetic media (such as hard disks, floppy disks, and/or any other suitable magnetic media), optical media (such as compact discs, digital video discs, Blu-ray discs, and/or any other suitable optical media), semiconductor media (such as flash memory, electrically programmable read only memory (EPROM), electrically erasable programmable read only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

The above described embodiments of the present disclosure are presented for purposes of illustration and not of limitation, and the present disclosure is limited only by the claims which follow.

What is claimed is:

1. A method for providing an entropy source, the method comprising:
receiving a user request for content;
obtaining a random sample value in response to receiving the user request for content;
generating, using a hardware processor, a request message including the random sample value based on the user request for content;
transmitting the request message;
receiving a response message corresponding to the request message; and
rendering the content based on the response message.

2. The method of claim 1, wherein the request message is an HTTP request message.

3. The method of claim 1, wherein the response message is an HTTP response message.

4. The method of claim 1, further comprising inserting the random sample value in a header of the request message.

5. The method of claim 1, further comprising:
measuring a plurality of random events; and
generating the random sample value based on the set of random events.

6. The method of claim 1, wherein the request message includes an identifier associated with the content.

7. The method of claim 1, wherein the user request for content includes a URI associated with the content.

8. A system for providing an entropy source, the system comprising:
at least a hardware processor that is configured to:
receive a user request for content;
obtain a random sample value in response to receiving the user request for content;
generate a request message including the random sample value based on the user request for content;
transmit the request message;
receive a response message corresponding to the request message; and
render the content based on the response message.

9. The system of claim 8, wherein the request message is an HTTP request message.

10. The system of claim 8, wherein the response message is an HTTP response message.

11. The system of claim 8, wherein the hardware processor is further configured to insert the random sample value in a header of the request message.

12. The system of claim 8, wherein the hardware processor is further configured to:
measure a plurality of random events; and
generate the random sample value based on the set of random events.

13. The system of claim 8, wherein the request message includes an identifier associated with the content.

14. The system of claim 8, wherein the user request for content includes a URI associated with the content.

15. A non-transitory computer-readable medium containing computer-executable instructions that, when executed by a processing circuitry, cause the processing circuitry to perform a method for providing an entropy source, the method comprising:
receiving a user request for content;
obtaining a random sample value in response to receiving the user request for content;
generating a request message including the random sample value based on the user request for content;
transmitting the request message;
receiving a response message corresponding to the request message; and
rendering the content based on the response message.

16. The non-transitory computer-readable medium of claim 15, wherein the request message is an HTTP request message.

17. The non-transitory computer-readable medium of claim 15, wherein the response message is an HTTP response message.

18. The non-transitory computer-readable medium of claim 15, wherein the method further comprises inserting the random sample value in a header of the request message.

19. The non-transitory computer-readable medium of claim 15, wherein the method further comprises:
measuring a plurality of random events; and
generating the random sample value based on the set of random events.

20. The non-transitory computer-readable medium of claim 15, wherein the request message includes an identifier associated with the content.

21. The non-transitory computer-readable medium of claim 15, wherein the user request for content includes a URI associated with the content.
